(19) United States
(12) Patent Application Publication
(10) Pub. No.: US 2013/0170333 A1
(43) Pub. Date: Jul. 4, 2013

(54) METHOD AND APPARATUS FOR TRANSMITTING AND RECEIVING A PILOT SEQUENCE IN A BROADCASTING COMMUNICATION SYSTEM

(71) Applicant: Samsung Electronics Co., Ltd., Gyeonggi-do (KR)

(72) Inventors: Sung-Ryul YUN, Gyeonggi-do (KR); Hong-Sil Jeong, Seoul (KR)

(73) Assignee: Samsung Electronics Co., Ltd., Gyeonggi-do (KR)

(21) Appl. No.: 13/729,483

(22) Filed: Dec. 28, 2012

(30) Foreign Application Priority Data
Dec. 28, 2011 (KR) 10-2011-0144255

(51) Int. Cl. H04J 11/00

(52) U.S. Cl. CPC H04J 11/00
USPC 370/208

(57) ABSTRACT

A method and an apparatus for transmitting and receiving a pilot sequence in an Single Carrier-Orthogonal Frequency Division Multiplexing (SC-OFDM) scheme of a broadcasting communication system. The method includes determining seed values for Orthogonal Frequency Division Multiplexing (OFDM) symbols; generating pilot sequences including information related to an OFDM symbol index by applying a Zadoff-Chu sequence to each of the seed values; inserting the pilot sequences into a determined subcarrier position in a frame according to a pilot pattern; and transmitting the frame.

### PRIORITY

This application claims priority under 35 U.S.C. §119(a) to Korean Application Serial No. 10-2011-0144255, which was filed in the Korean Intellectual Property Office on Dec. 28, 2011, the entire disclosure of which is hereby incorporated by reference.

### BACKGROUND OF THE INVENTION

1. Field of the Invention

The present invention relates generally to a broadcasting communication system, and more particularly, to a method and an apparatus for transmitting and receiving a pilot sequence in a Single Carrier-Orthogonal Frequency Division Multiplexing (SC-OFDM) scheme of a broadcasting communication system.

2. Description of the Related Art

In general, a broadcasting communication system provides a broadcasting communication service having a high transmission speed and various Quality of Service (QoS). For example, the broadcasting communication system uses a multi-carrier scheme that transmits data through a plurality of subcarriers arranged to maintain orthogonality, e.g., an Orthogonal Frequency Division Multiplexing (OFDM) scheme, to provide a high transmission speed and different QoS. The OFDM scheme has an advantage in that it has a high frequency use efficiency and is strong on multi path fading.

Because of these advantages, the OFDM scheme has been adopted as the standard of communication systems such as large capacity broadcasting systems including European Digital Audio Broadcasting (DAB), Digital Video Broadcasting (DVB), and Long Term Evolution (LTE).

However, the OFDM scheme has a disadvantage in that it has a high Peak to Average Power Ratio (PAPR).

### SUMMARY OF THE INVENTION

Accordingly, the present invention is designed to address at least the problems and/or disadvantages described above and to provide at least the advantages described below.

An aspect of the present invention is to provide a method of transmitting and receiving a pilot sequence in a broadcasting communication system.

Another aspect of the present invention is to provide a method of transmitting and receiving a pilot sequence in a broadcasting communication system using an SC-OFDM scheme.

Another aspect of the present invention is to provide a method of transmitting and receiving a pilot sequence that reduces a PAPR in a broadcasting communication system using an SC-OFDM scheme.

Another aspect of the present invention is to provide a method of transmitting and receiving a pilot sequence that reduces power consumption by transmitting an OFDM symbol index information in order to quickly synchronize a receiver.

In accordance with an aspect of the present invention, a method of transmitting a pilot sequence in a broadcasting communication system is provided. The method includes determining seed values for Orthogonal Frequency Division Multiplexing (OFDM) symbols; generating pilot sequences including information related to an OFDM symbol index by applying a Zadoff-Chu sequence to each of the seed values; inserting the pilot sequences into a determined subcarrier position in a frame according to a pilot pattern; and transmitting the frame.

In accordance with another aspect of the present invention, a method of receiving a pilot sequence in a broadcasting communication system is provided. The method includes detecting a position of a pilot subcarrier in a received frame, by comparing sizes of the pilot subcarrier and a data subcarrier included in a received frame; identifying a pilot sequence corresponding to the position of the pilot subcarrier; detecting a seed value from the pilot sequence; and detecting information related to an Orthogonal Frequency Division Multiplexing (OFDM) symbol index, using the position of the pilot subcarrier and the seed value. The pilot sequences are inserted into a determined subcarrier position of the frame according to a pilot pattern, and the pilot sequence is generated by applying a Zadoff-Chu sequence to each of a plurality of seed values including the seed value.

In accordance with another aspect of the present invention, an apparatus for transmitting a pilot sequence in a broadcasting communication system is provided. The apparatus includes a control unit that determines seed values for Orthogonal Frequency Division Multiplexing (OFDM) symbols, generates pilot sequences including information related to an OFDM symbol index by applying a Zadoff-Chu sequence to each of the seed values, and inserts the pilot sequences into a determined subcarrier position in a frame according to a pilot pattern; and a transmission unit that transmits the frame.

In accordance with another aspect of the present invention, an apparatus for receiving a pilot sequence in a broadcasting communication system is provided. The apparatus includes a reception unit that receives a frame from a transmitter; and a control unit that detects a position of a pilot subcarrier included in the frame by comparing sizes of the pilot subcarrier and a data subcarrier included in the frame, identifies a pilot sequence corresponding to the position of the pilot subcarrier, detects a seed value from the pilot sequence, and detects information related to an Orthogonal Frequency Division Multiplexing (OFDM) symbol index, using the position of the pilot subcarrier and the seed value. The pilot sequences are inserted into a determined subcarrier position of the frame according to a pilot pattern, and the pilot sequence is generated by applying a Zadoff-Chu sequence to each of a plurality of seed values including the seed value.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIGS. 1 and 2 illustrate a broadcasting communication system using an SC-OFDM scheme according to an embodiment of the present invention;

FIG. 3 illustrates an SC-OFDM frame configuration in which a pilot subcarrier and a data subcarrier are separated in a time domain according to an embodiment of the present invention;

FIG. 4 illustrates a DVB-T2 frame configuration in which a pilot subcarrier and a data subcarrier are simultaneously transmitted to an OFDM symbol according to an embodiment of the present invention;

FIG. 5 illustrates a super frame configuration of a digital broadcasting communication system according to an embodiment of the present invention;

FIG. 6 illustrates a frame configuration in which a data stream is transmitted to a Physical Layer Pipe (PLP) according to an embodiment of the present invention;

FIG. 7 illustrates a PAPR reduction capability of an SC-OFDM scheme according to an embodiment of the present invention;

FIG. 8 is a flowchart illustrating a method of transmitting a pilot sequence by a transmitter according to an embodiment of the present invention;

FIG. 9 is a flowchart illustrating a method of receiving a pilot sequence by a receiver according to an embodiment of the present invention;

FIG. 10 illustrates a pilot insertion unit according to an embodiment of the present invention; and

FIG. 11 illustrates a channel estimation and pilot removal unit according to an embodiment of the present invention.

### DETAILED DESCRIPTION OF EMBODIMENTS OF THE INVENTION

Hereinafter, various embodiments of the present invention will be described with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

As described above, in accordance with an embodiment of the present invention, a method of transmitting and receiving a pilot sequence is provided, which is effective in reducing PAPR, wherein a transmitter of the broadcasting communication system can generate a transmission signal of a lower PAPR in an SC-OFDM scheme and a receiver detects OFDM symbol index information using the pilot sequence. As a result, the receiver quickly and accurately performed frame synchronization, thereby reducing power consumption.

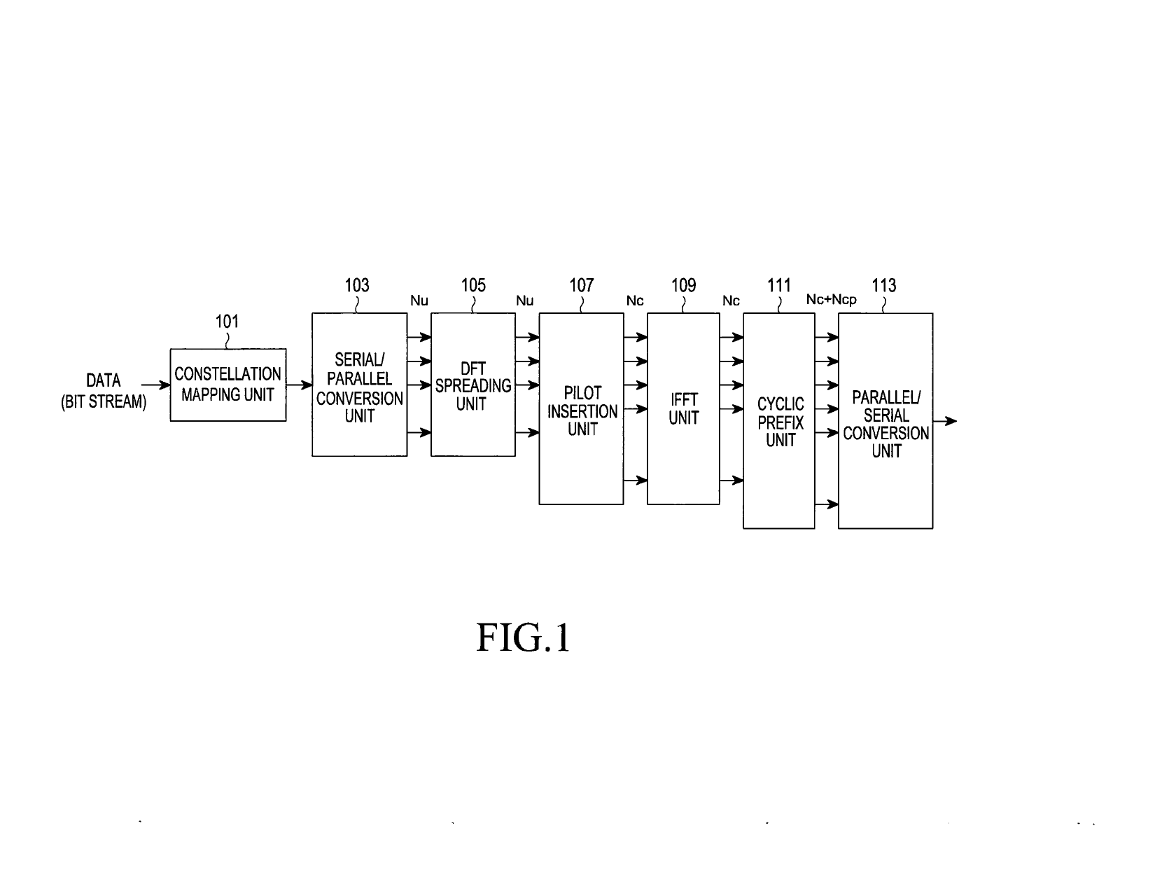

FIGS. 1 and 2 illustrates a broadcasting communication system using an SC-OFDM according to an embodiment of the present invention. Specifically, FIG. 1 illustrates a transmitter, and FIG. 2 illustrates a receiver.

In FIG. 1, a difference between an SC-OFDM scheme according to an embodiment of the present invention and a conventional OFDM scheme is that a transmission signal is precoded before being input into an Inverse Fast Fourier Transform (IFFT) unit 109, in order to reduce PAPR. Specifically, the precoding is performed by a Discrete Fourier Transform (DFT) spreading unit 105.

Referring to FIG. 1, the transmitter includes a constellation mapping unit 101, a serial/parallel conversion unit 103, the DFT spreading unit 105, a pilot insertion unit 107, the IFFT unit 109, a Cyclic Prefix (CP) insertion unit 111, and a parallel/serial conversion unit 113. Herein, the term “unit” refers to a hardware device or a combination of a hardware device and software.

The constellation mapping unit 101 modulates input data (e.g., bit stream) to a symbol of Quadrature Amplitude Modulation (QAM) and Phase Shift Keying (PSK). Further, the serial/parallel conversion unit 103 configures the modulated symbol as parallel values of length of Nu.

As described above, in the conventional OFDM transmission method, the parallel values are directly input into the IFFT unit 109, but in accordance with an embodiment of the present invention, the parallel values are precoded in the DFT spreading unit 105 using a Nu-point DFT operation, in order to reduce PAPR.

The pilot insertion unit 107 generates a pilot sequence and inserts the generated pilot sequence into a subcarrier position determined according to a pilot pattern. A method of generating the pilot sequence will be described in more detail below with reference to Equation (3).

The IFFT unit 109 performs an Nc point IFFT operation for a mapped signal. The CP (or guard interval) insertion unit 111 inserts a CP (Ncp) into an output signal of the IFFT unit 109, and the parallel/serial conversion unit 113 converts the parallel signal into which the CP is inserted to a serial signal and then transmits the serial signal to a receiver via a transmission unit (not shown).

Referring to FIG. 2, the receiver includes a serial/parallel conversion unit 201, a CP removal unit 203, a Fast Fourier Transform (FFT) unit 205, a channel estimation and pilot removal unit 207, a DFT transmitter de-spreading unit 209, a parallel/serial conversion unit 211, and a constellation de-mapping unit 213.

The serial/parallel conversion unit 201 converts a signal received through a reception unit (not shown) to a parallel signal, and the CP removal unit 203 removes a CP (or a guard interval) from the parallel signal. The FFT unit 205 performs an Nc point FFT operation. The converted signal includes a pilot subcarrier and a data subcarrier, and the channel estimation and pilot removal unit 207 performs channel estimation using the pilot subcarrier and then detects OFDM symbol index information using a pilot sequence generated, e.g., using Equation (3), as will be described below. Further, the channel estimation and pilot removal unit 207 removes the pilot, after performing channel estimation and detecting the OFDM symbol index information.

The DFT transmitter de-spreading unit 209 converts a signal to a desired signal through an inverse process of the DFT spreading of the transmitter. The parallel/serial conversion unit 211 converts the converted signal into a serial signal, and the constellation de-mapping unit 213 outputs data through constellation de-mapping of the converted serial signal.

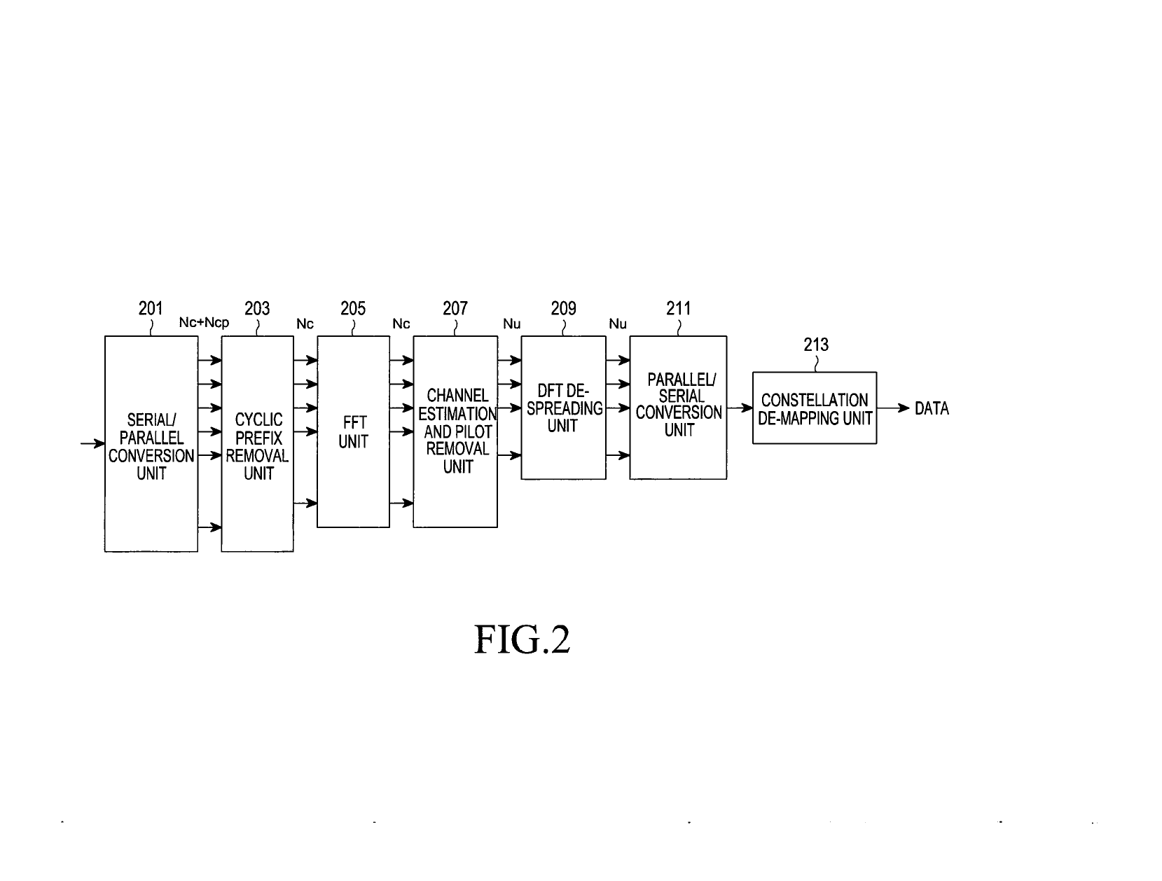

In order to reduce the PAPR, in accordance with an embodiment of the present invention, an SC-OFDM frame structure is provided, in which the pilot subcarrier and the data subcarrier are separated in a time domain and then transmitted, as illustrated in FIG. 3. The SC-OFDM frame structure is applied to the DVB-T2 frame structure.

FIG. 3 illustrates an SC-OFDM frame configuration in which a pilot subcarrier and a data subcarrier are separated in a time domain according to an embodiment of the present invention.

Referring to FIG. 3, with respect to the pilot OFDM symbol, the pilot subcarrier for the channel estimation is directly input into the IFFT unit 109, and the data subcarrier is input into the IFFT unit 109, after the precoding, e.g., using the DFT.

However, a frame structure of a terrestrial digital broadcasting communication system (DVB-T2) is different from the SC-OFDM frame structure illustrated FIG. 3.

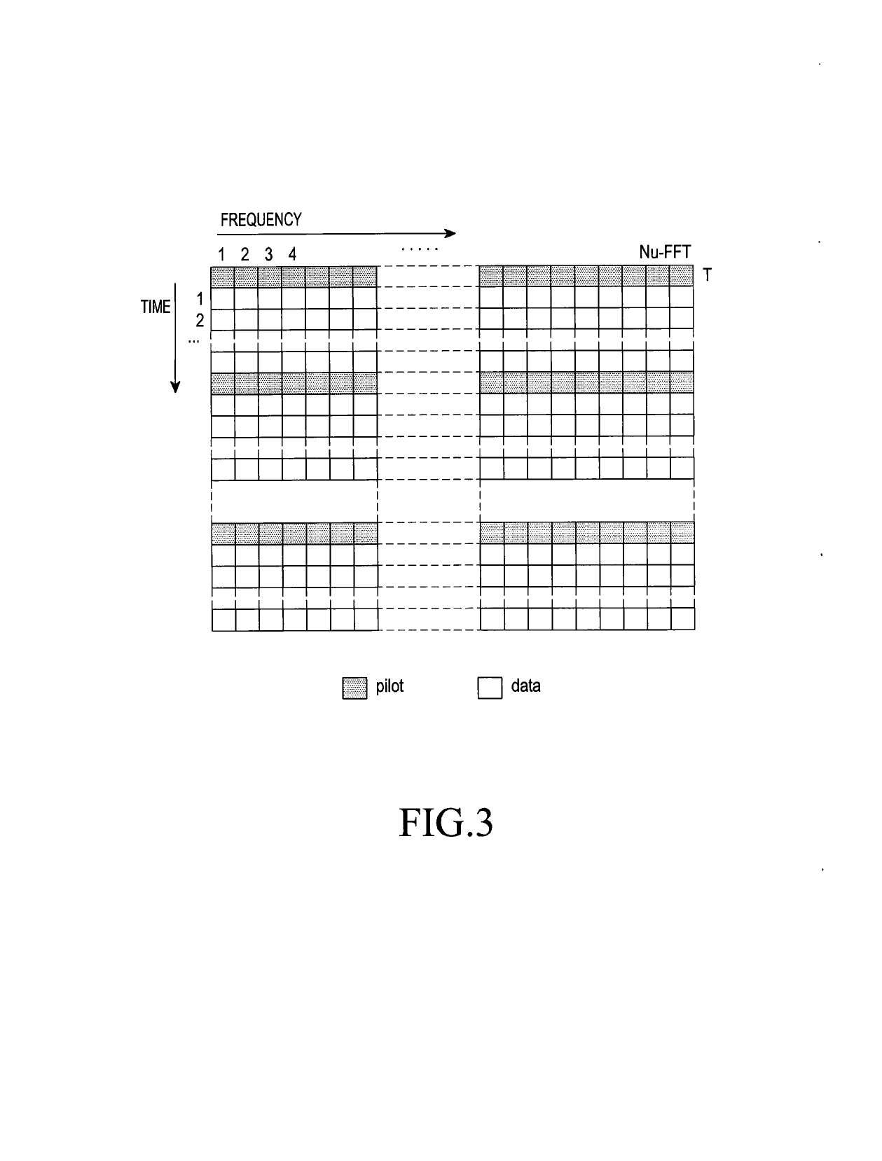

FIG. 4 illustrates a DVB-T2 frame structure according to an embodiment of the present invention. Referring to FIG. 4, in the DVB-T2 frame structure, the data subcarrier and the pilot subcarrier coexist in the OFDM symbol. In order to apply the SC-OFDM frame structure to the DVB-T2 frame structure, only the data subcarrier is precoded and the pilot subcarrier is not precoded. If the pilot subcarrier is precoded, the pilot subcarrier spreads to a total subcarrier, and the channel estimation cannot be performed. That is, in FIG. 4, a problem occurs in which the PAPR reduction capability is significantly reduced in the SC-OFDM frame structure. Accordingly, a method of generating the pilot sequence that maintains the PAPR reduction capability in the SC-OFDM frame structure is required.

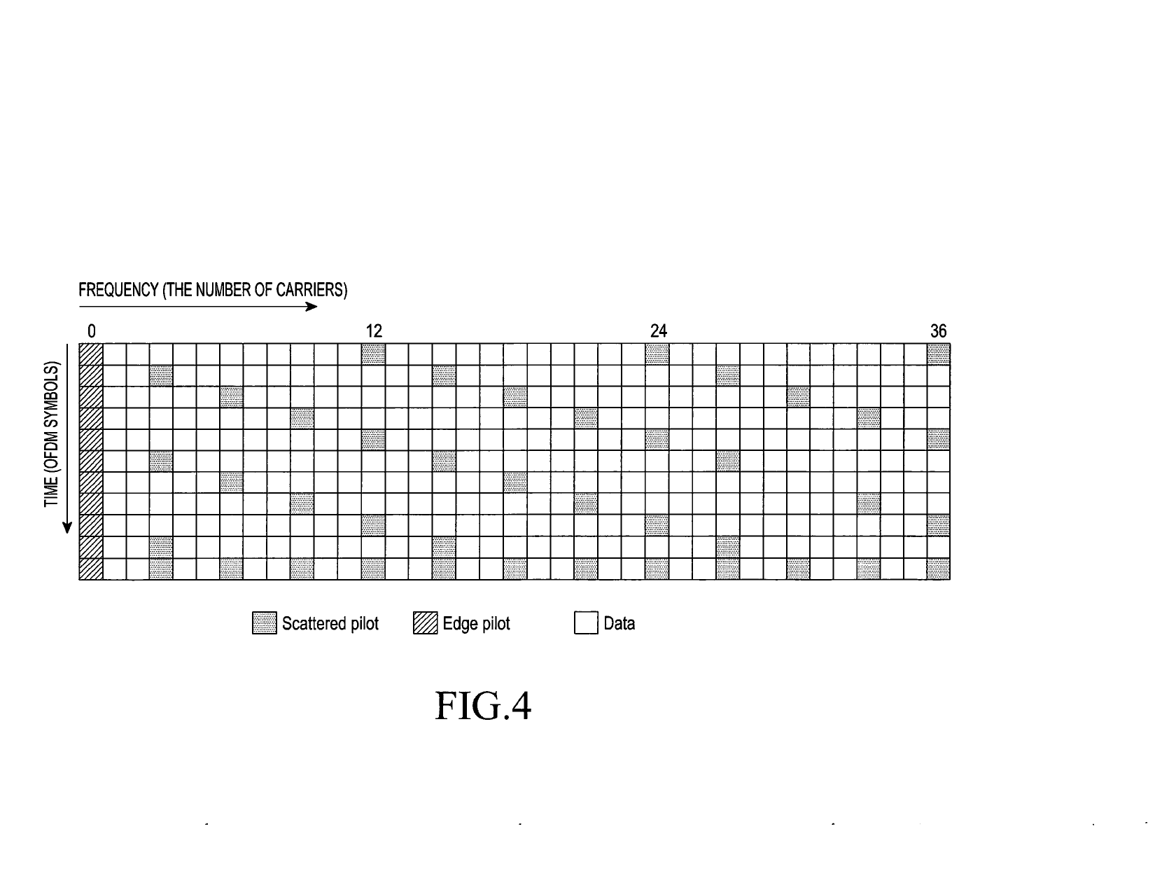

FIG. 5 illustrates a super-frame structure in a digital broadcasting system according to an embodiment of the present invention. Here, the super-frame includes a plurality of frames, wherein a start part of the frame includes symbols of P1 and P2, and information on an FFT size, Single Input Single Output (SISO)/Multiple Input Single Output (MISO), etc., is transmitted in the P1 symbol. Further, signaling information indicating the frame structure is transmitted in the P2 symbol. A last part of the frame includes data subcarriers to transmit data. Here, the data subcarriers include M OFDM symbols of S₁, S₂, . . . , S_{M}. A plurality of frame structures, as described above are arranged into one super-frame.

A data stream of the broadcasting service is transmitted to a PLP in a Time Division Multiplexing (TDM) system.

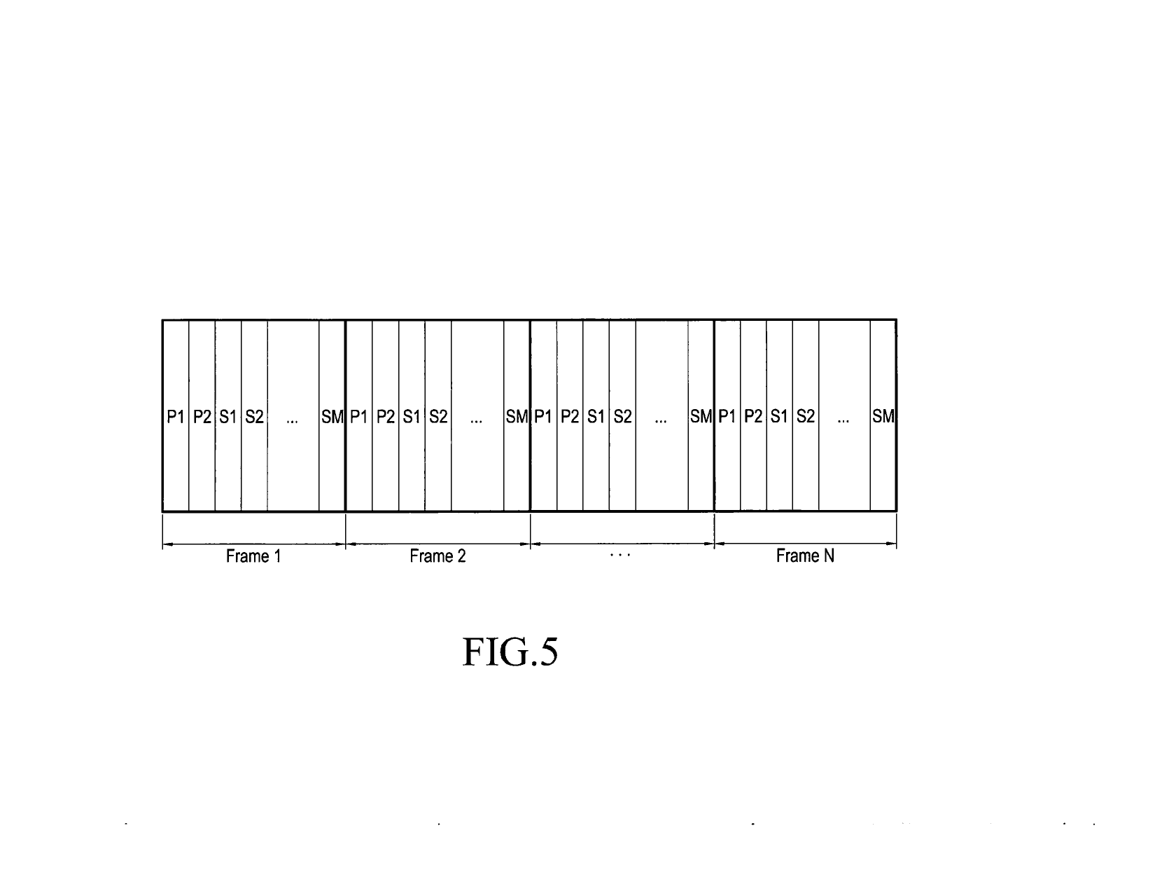

FIG. 6 illustrates a frame structure in which a data stream is transmitted to a PLP according to an embodiment of the present invention.

Referring to FIG. 6, position information on the PLP of each frame is transmitted through L1 signaling information of the P2 symbol. The receiver correctly receives data of each PLP through the L1 signaling information.

The receiver can reduce power consumption by using features of the data stream (i.e., a feature that data is not transmitted over an entire frame section). The receiver is not always in an on state during the entire frame section, and the receiver receives the data in a section where the PLP is transmitted and is switched to an idle mode in other sections. Accordingly, through the above process, the power consumption of the receiver can be reduced. For the rapid switching to the idle mode of the receiver, a quicker and more accurate frame synchronization is required.

Referring again to FIG. 4, the pilot structure (except for the symbols P1 and P2 of FIG. 5) may be represented by Equation (1).

k mod(DₓD_{y})=Dₓ(l mod D_{y}) (1)

In Equation (1), k denotes a subcarrier index of the OFDM symbol, l denotes an index of the OFDM symbol, and Dₓ denotes an interval at which a pilot signal in a next OFDM symbol is shifted and may be indicated by the number of subcarriers. That is, Dₓ refers to a subcarrier separation distance (the number of subcarriers). D_{y} denotes an interval (hereinafter, referred to as an “OFDM symbol interval”) at which a scattered pilot is repeatedly located in the same subcarrier. For example, D_{y} may be indicated by the number of OFDM symbols.

A pilot pattern may be configured by a combination of Dₓ and D_{y} having various values in the broadcasting communication system, and the pilot pattern of FIG. 4 corresponds to a case where Dₓ=3 and D_{y}=4.

Table 1 below shows seven pilot patterns applied to the broadcasting communication system.

TABLE 1

| | | | Number of pilot carriers | | | |
|---|---|---|---|---|---|---|
| Pilot pattern | DX | DY | 2K | 4K | 8K | 16K |
| PP1 | 3 | 4 | 143 | 285 | 569 | 1137 |
| PP2 | 6 | 2 | 143 | 285 | 569 | 1137 |
| PP3 | 6 | 4 | 72 | 143 | 285 | 569 |
| PP4 | 12 | 2 | 72 | 143 | 285 | 569 |
| PP5 | 12 | 4 | 36 | 72 | 143 | 285 |
| PP6 | 24 | 2 | 36 | 72 | 143 | 285 |
| PP7 | 24 | 4 | 18 | 36 | 72 | 143 |

Table 1 shows the number of pilot subcarriers according to an FFT size, Dₓ, and D_{y}. Accordingly, in accordance with an embodiment of the present invention, the pilot sequence is generated for various lengths.

Reference values for the channel estimation are applied to the pilot subcarriers. When a random binary value is input, characteristics of the precoded data are changed, so that the PAPR capability is reduced. Accordingly, the reference values of the pilot subcarriers should be filled with values suitable for the channel estimation while maintaining PAPR reduction characteristics.

Accordingly, in accordance with an embodiment of the present invention, Zadoff-Chu sequence characteristics are used as values of the pilot subcarriers. When the Zadoff-Chu sequence characteristics are configured by complex values, they are expressed as shown in Equation (2).

$${x}_{u} ( n ) = {e}^{- j \frac{π u n ( n - 1 )}{N}} , 0 \leq n \leq N - 1 \qquad ( 2 )$$

In Equation (2) above, xᵤ denotes a pilot sequence to which a Zadoff-Chu sequence is applied, N denotes the number of pilot subcarriers in table 1, u denotes a seed value of generating a Zadoff-Chu sequence.

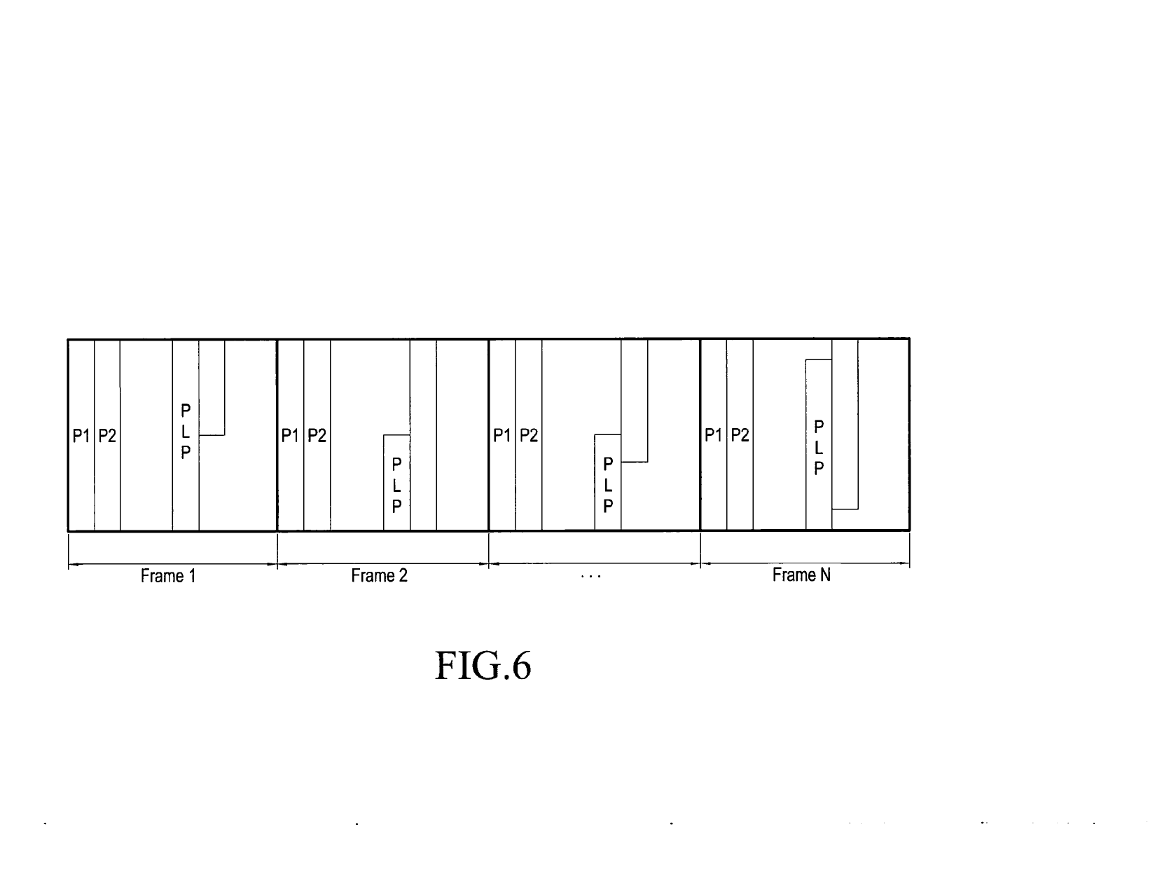

FIG. 7 illustrates a PAPR reduction capability of an SC-OFDM scheme according to an embodiment of the present invention. Specifically, in the SC-OFDM scheme where the pilot subcarrier and the data subcarrier coexist, the PAPR reduction capability of the SC-OFDM scheme when the Zadoff-Chu sequence is applied to the pilot subcarrier is as illustrated in FIG. 7.

Referring to FIG. 7, compared to the OFDM system, the SC-OFDM to which the pilot sequence according to an embodiment of the present invention is applied shows an improved PAPR effect by 3 dB.

In accordance with an embodiment of the present invention, a method is provided for informing an accurate position of a pilot signal by using the pilot sequence in the SC-OFDM system.

In the frame structures illustrated in FIGS. 4 and 5, the OFDM symbol index information for each OFDM symbol is transmitted to the subcarrier through the pilot sequence, so that the receiver can know the OFDM symbol index information by using the pilot sequence.

The pilot sequence including the OFDM symbol index information may be generated, using the pilot subcarrier structure illustrated FIG. 4 and the Zadoff-Chu sequence characteristics, as defined in Equation (3) below.

$${x}_{l} ( n ) = {e}^{- j \frac{π {u}_{l} n ( n - 1 )}{{N}_{p}}} , \\ 0 \leq n \leq {N}_{p} - 1 , \\ {u}_{l} = ⌊ \frac{l}{{D}_{y}} ⌋ . \qquad ( 3 )$$

In Equation (3), xₗ(n) denotes a pilot sequence of a first OFDM symbol, and Nₚ denotes a length of the pilot sequence. Further, uₗ denotes a seed value of generating a Zadoff-Chu sequence in a l^{th} OFDM symbol. The seed value is determined according to the OFDM symbol interval D_{y} at which the pilot sequence is repeatedly located in the same frequency. Accordingly, the same Zadoff-Chu sequence is generated during the OFDM symbol interval D_{y} by the same seed value. However, because the shift interval of the subcarrier is changed by Dₓ whenever the OFDM symbol increases, symbols during the OFDM symbol interval D_{y} can be distinguished.

More specifically, when the transmitter transmits the OFDM symbol index information as shown in Equation (3), one seed value becomes the same value between D_{y} OFDM symbols, and the D_{y} OFDM symbols are distinguished through position information of the scattered pilot pattern.

An example of the pilot sequence transmitting the OFDM symbol index information in the SC-OFDM scheme by using Equation (3) is shown below.

$$l = 0 \to {x}_{0} ( n ) = {e}^{- j \frac{π {u}_{0} n ( n - 1 )}{{N}_{p}}} , {u}_{0} = 0 , k mod ( DxDy ) = 0$$

$$l = 1 \to {x}_{1} ( n ) = {e}^{- j \frac{π {u}_{1} n ( n - 1 )}{{N}_{p}}} , {u}_{1} = 0 , k mod ( DxDy ) = 3$$

$$l = 2 \to {x}_{2} ( n ) = {e}^{- j \frac{π {u}_{2} n ( n - 1 )}{{N}_{p}}} , {u}_{2} = 0 , k mod ( DxDy ) = 6$$

$$l = 3 \to {x}_{3} ( n ) = {e}^{- j \frac{π {u}_{3} n ( n - 1 )}{{N}_{p}}} , {u}_{3} = 0 , k mod ( DxDy ) = 9$$

$$l = 4 \to {x}_{4} ( n ) = {e}^{- j \frac{π {u}_{4} n ( n - 1 )}{{N}_{p}}} , {u}_{4} = 1 , k mod ( DxDy ) = 0$$

$$⋮ ⋮$$

In accordance with an embodiment of the present invention, OFDM symbol index information is transmitted by generating a pilot sequence using a structure of a scattered pilot of a broadcasting communication system and a seed value of a Zadoff-Chu sequence. Accordingly, because each OFDM symbol does not use different seed values, all OFDM symbol indexes can be represented by the small number of seed values.

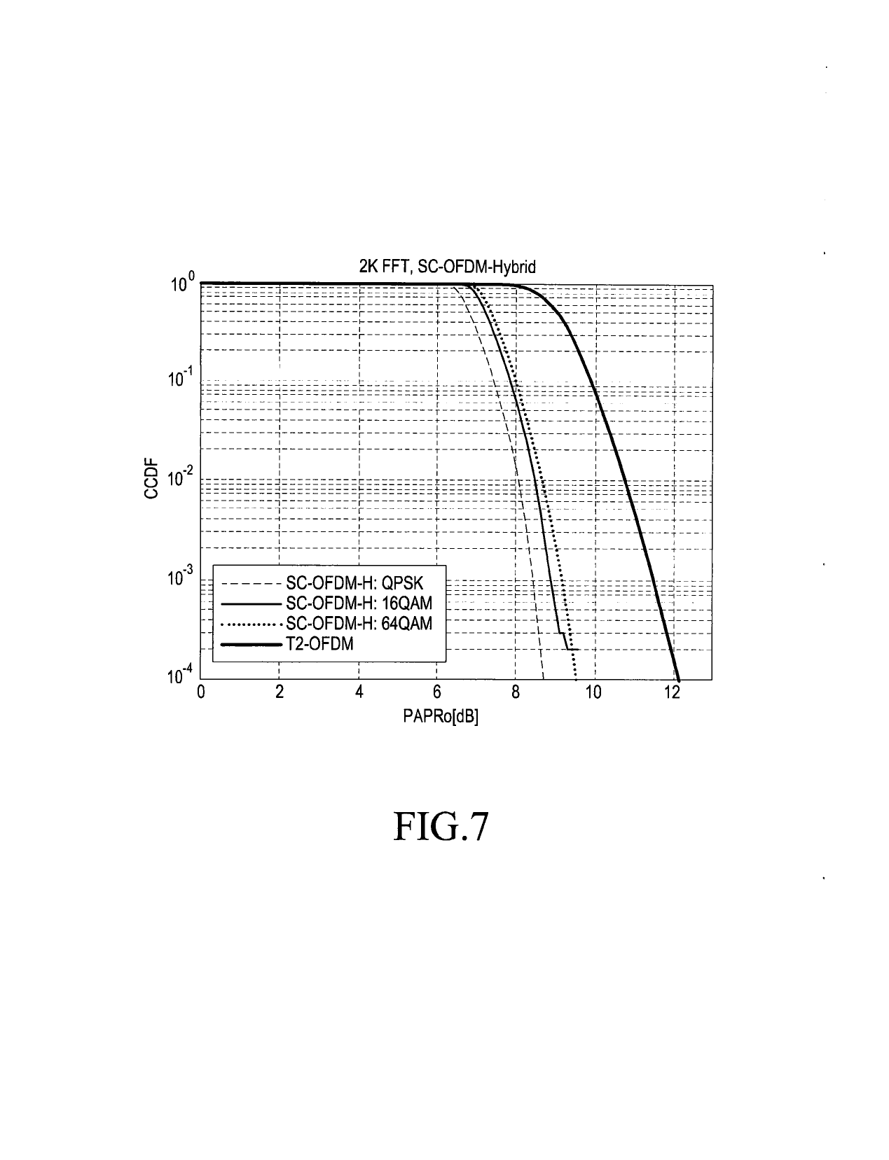

FIG. 8 is a flowchart illustrating a method in which a transmitter transmits a pilot sequence according to an embodiment of the present invention. Specifically, FIG. 8 illustrates a method of transmitting the pilot sequence in the broadcasting frame including M OFDM symbols, as illustrated in FIG. 4. Further, the method of FIG. 8 in which the transmitter transmits the pilot sequence is performed by the pilot insertion unit 107 illustrated in FIG. 1.

Referring to FIG. 8, the pilot insertion unit 107 starts at an index (l=0) of the OFDM symbol in step 801, and calculates a seed value for generating the pilot sequence in step 803. Here, the seed value is

$${u}_{l} = ⌊ \frac{l}{{D}_{y}} ⌋$$

### in Equation (3).

In step 805, the pilot insertion unit 107 generates the pilot sequence having a length of Nₚ by using Equation (3). In step 807, the pilot insertion unit 107 generates the pilot pattern in which the pilot sequence is shifted according to the index of the OFDM symbol as shown in Equation (1).

In step 809, the pilot insertion unit 107 inserts the generated pilot sequence into a position of each subcarrier set according the pilot pattern. In step 811, the pilot insertion unit 107 identifies whether the index (I) of the OFDM symbol is smaller than M. The pilot insertion unit 107 increases the index of the OFDM symbol in step 813 and then repeats steps 803 to 811, when the index of the OFDM symbol is smaller than M, and ends the process when the index of the OFDM symbol is larger than M.

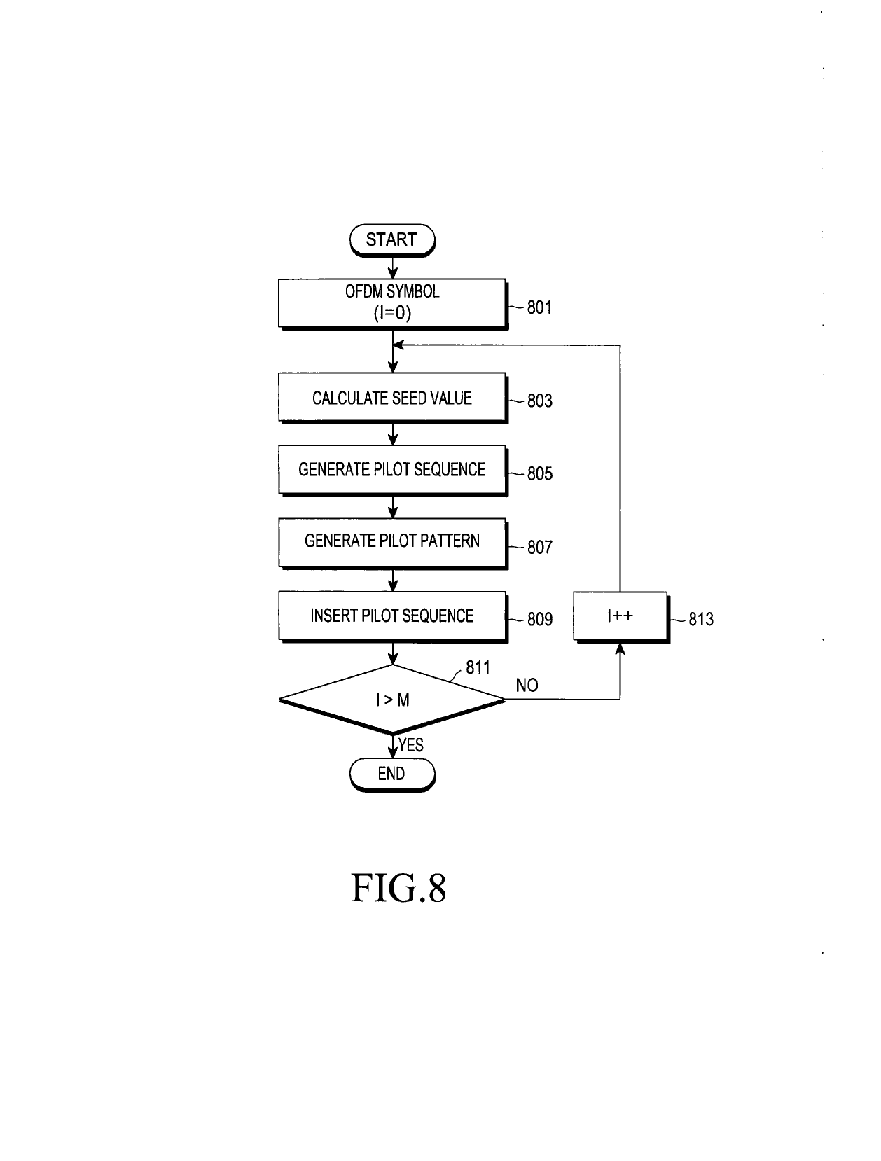

FIG. 9 illustrates a method in which a receiver receives a pilot sequence according to an embodiment of the present invention. Specifically, the method of FIG. 9 is performed by the channel estimation and pilot removal unit 207 illustrated in FIG. 2.

Referring to FIG. 9, in step 901, the channel estimation and pilot removal unit 207 demodulate the frame received from the transmitter. The demodulated frame includes the data subcarrier and the pilot subcarrier having complex values. In step 903, the channel estimation and pilot removal unit 207 compares sizes of the pilot subcarrier and the data subcarrier and detects a position of the pilot subcarrier. Accordingly, the channel estimation and pilot removal unit 207 can know a values of l mod D_{y} according to the position of the pilot subcarrier.

In step 905, the channel estimation and pilot removal unit 207 calculates autocorrelation of the received pilot sequence using Equation (3) and detects a seed value (uₗ). In step 907, the channel estimation and pilot removal unit 207 detects OFDM symbol index information (Dₓuₗ+l mod D_{y}) by using the position value (l mod D_{y}) of the pilot subcarrier and the seed value (uₗ). Because the receiver knows the OFDM symbol index information, when the transmitter transmits the pilot sequence according to an embodiment of the present invention, quick and accurate switching can be achieved when one Radio Frequency (RF) is changed into another RF. Further, because the receiver knows the OFDM symbol index information, there is an advantage in that power consumption can be reduced by using a clock of lower power in an idle mode.

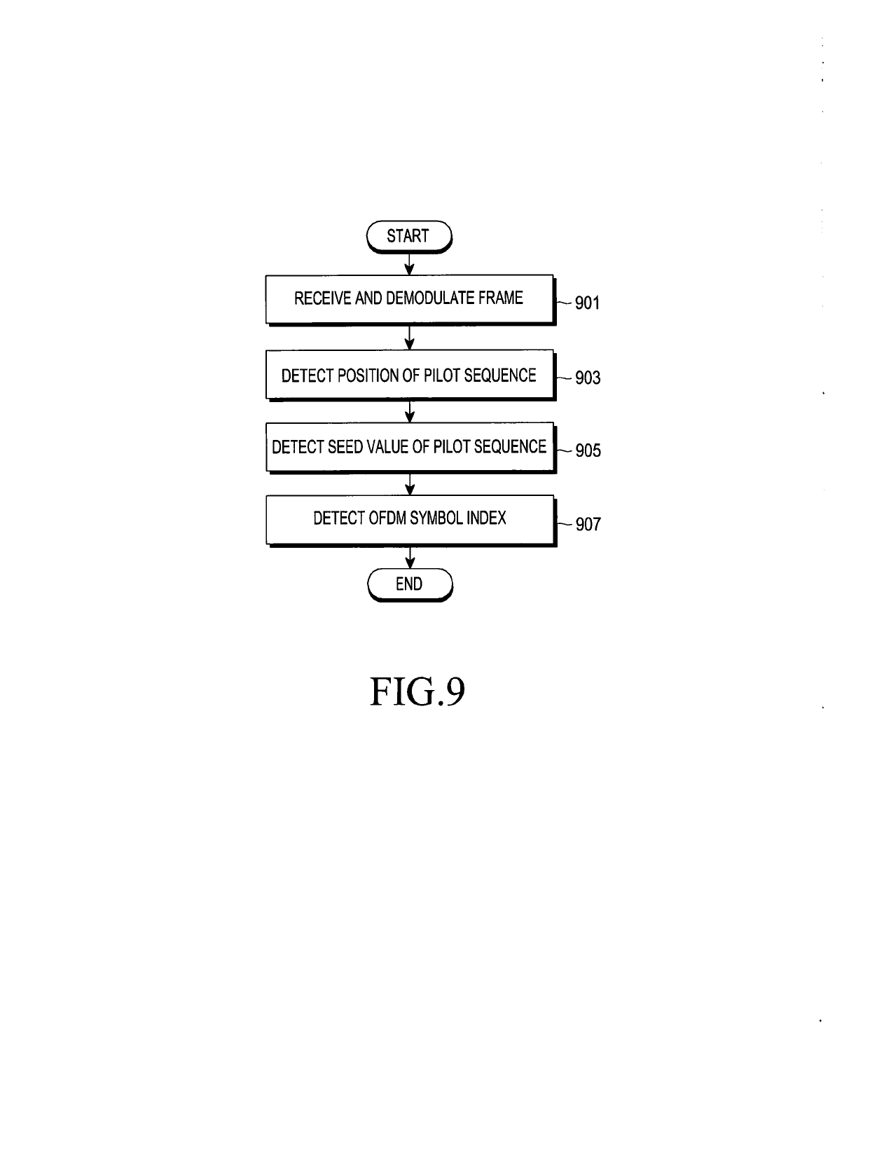

FIG. 10 illustrates a pilot insertion unit according to an embodiment of the present invention.

Referring to FIG. 10, the pilot insertion unit 107 includes a reception unit 1001, a transmission unit 1003, and a control unit 1005.

The reception unit 100 receives precoded data from the DFT spreading unit 105, as illustrated in FIG. 1. The control unit 1005 determines a seed value for generating the pilot sequence according to an index of the OFDM symbol and then generates the pilot sequence using Equation (3), as described above. Further, the control unit 1005 generates the pilot pattern in which the pilot sequence is shifted according to the index of the OFDM symbol and inserts the generated pilot sequence into a position of each subcarrier determined according to the generated pilot pattern. The transmission unit 1003 transmits a frame including the pilot subcarrier and the data subcarrier to the IFFT unit 109.

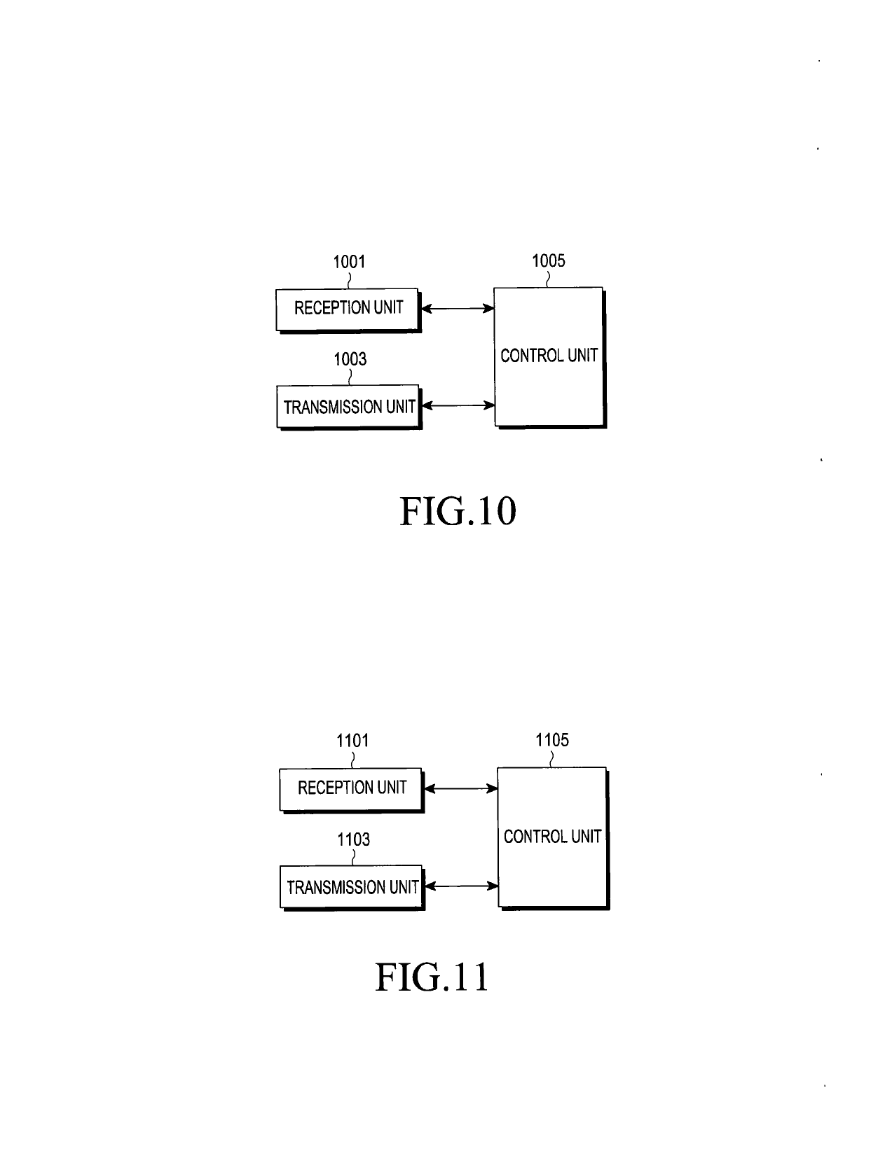

FIG. 11 illustrates a channel estimation and pilot removal unit according to an embodiment of the present invention.

Referring to FIG. 11, the channel estimation and pilot removal unit 207 includes a reception unit 1101, a transmission unit 1103, and a control unit 1105.

The reception unit 1101 receives a frame including a data subcarrier and a pilot subcarrier from the FFT unit 205, as illustrated in FIG. 2. The control unit 1105 demodulates the received frame, compares sizes of the pilot subcarrier and the data subcarrier included in the demodulated frame, and then detects a position of the pilot subcarrier. Accordingly, the control unit 1105 can know a position value of l mod D_{y} according to the position of the pilot subcarrier. Further, the control unit 1105 detects a seed value by calculating autocorrelation of the received pilot sequence by using Equation (3) and then detects OFDM symbol index information (Dₓuₗ+l mod D_{y}) by using the position value l mod D_{y} of the pilot subcarrier and the seed value (uₗ).

Although the reception units 1001 and 1101 and the transmission units 1003 and 1103 are implemented as separated blocks in FIGS. 10 and 11, they can be implemented as one block, i.e., a single transceiver unit.

While the present invention has been shown and described with reference to certain embodiments thereof, it will be understood by those skilled in the art that various changes in form and details may be made therein without departing from the spirit and scope of the present invention as defined by the appended claims and equivalents thereof.

What is claimed is:

1. A method of transmitting a pilot sequence in a broadcasting communication system, the method comprising:
determining seed values for Orthogonal Frequency Division Multiplexing (OFDM) symbols;
generating pilot sequences including information related to an OFDM symbol index by applying a Zadoff-Chu sequence to each of the seed values;
inserting the pilot sequences into a determined subcarrier position in a frame according to a pilot pattern; and
transmitting the frame.

2. The method of claim 1, wherein the seed values are determined according to OFDM symbol intervals.

3. The method of claim 2, wherein each of the seed values is defined as
$${u}_{l} = ⌊ \frac{l}{{D}_{y}} ⌋ ,$$
where D_{y} denotes an OFDM symbol interval, and l denotes a position of the OFDM symbol.

4. The method of claim 3, wherein the pilot sequences are defined as
$${x}_{l} ( n ) = {e}^{- j \frac{π {u}_{l} n ( n - 1 )}{{N}_{p}}} , \\ 0 \leq n \leq {N}_{p} - 1$$
where xₗ(n) denotes a pilot sequence of a first OFDM symbol, and Nₚ denotes a length of the pilot sequence of the first OFDM symbol.

5. The method of claim 4, wherein the information related to the OFDM symbol index is defined as Dₓuₗ+l mod D_{y},
where l mod D_{y} denotes a position value of the pilot subcarrier, uₗ denotes the seed value, and Dₓ denotes an interval at which the pilot sequence is shifted.

6. A method of receiving a pilot sequence in a broadcasting communication system, the method comprising:
detecting a position of a pilot subcarrier in a received frame, by comparing sizes of the pilot subcarrier and a data subcarrier included in a received frame;
identifying a pilot sequence corresponding to the position of the pilot subcarrier;
detecting a seed value from the pilot sequence; and
detecting information related to an Orthogonal Frequency Division Multiplexing (OFDM) symbol index, using the position of the pilot subcarrier and the seed value,
wherein the pilot sequences are inserted into a determined subcarrier position of the frame according to a pilot pattern, and
wherein the pilot sequence is generated by applying a Zadoff-Chu sequence to each of a plurality of seed values including the seed value.

7. The method of claim 6, wherein the seed value is determined according to an OFDM symbol interval.

8. The method of claim 7, wherein the seed value is defined as
$${u}_{l} = ⌊ \frac{l}{{D}_{y}} ⌋ ,$$
where D_{y} denotes the OFDM symbol interval and I denotes a position of an OFDM symbol.

9. The method of claim 8, wherein the pilot sequence is defined as
$${x}_{l} ( n ) = {e}^{- j \frac{π {u}_{l} n ( n - 1 )}{{N}_{p}}} , \\ 0 \leq n \leq {N}_{p} - 1$$
where xₗ(n) denotes a pilot sequence of a first OFDM symbol, and Nₚ denotes a length of the pilot sequence of the first OFDM symbol.

10. The method of claim 9, wherein the information related to the OFDM symbol index is defined as Dₓuₗ+l mod D_{y},
where l mod D_{y} denotes a position value of the pilot subcarrier, uₗ denotes the seed value, and Dₓ denotes an interval at which the pilot sequence is shifted.

11. An apparatus for transmitting a pilot sequence in a broadcasting communication system, the apparatus comprising:
a control unit that determines seed values for Orthogonal Frequency Division Multiplexing (OFDM) symbols, generates pilot sequences including information related to an OFDM symbol index by applying a Zadoff-Chu sequence to each of the seed values, and inserts the pilot sequences into a determined subcarrier position in a frame according to a pilot pattern; and
a transmission unit that transmits the frame.

12. The apparatus of claim 11, wherein the seed values are determined according to OFDM symbol intervals.

13. The apparatus of claim 12, wherein each of the seed values are defined as
$${u}_{l} = ⌊ \frac{l}{{D}_{y}} ⌋ ,$$
where D_{y}, denotes the OFDM symbol interval, and l denotes a position of the OFDM symbol.

14. The apparatus of claim 13, wherein the pilot sequences are defined as
$${x}_{l} ( n ) = {e}^{- j \frac{π {u}_{l} n ( n - 1 )}{{N}_{p}}} , \\ 0 \leq n \leq {N}_{p} - 1$$
where xₗ(n) denotes a pilot sequence of a first OFDM symbol, and Nₚ denotes a length of the pilot sequence of the first OFDM symbol.

15. The apparatus of claim 14, wherein the information related to the OFDM symbol index is defined as Dₓuₗ+l mod D_{y},
where l mod D_{y} denotes a position value of the pilot subcarrier, uₗ denotes the seed value, and Dₓ denotes an interval at which the pilot sequence is shifted.

16. An apparatus for receiving a pilot sequence in a broadcasting communication system, the apparatus comprising:
a reception unit that receives a frame from a transmitter; and
a control unit that detects a position of a pilot subcarrier included in the frame by comparing sizes of the pilot subcarrier and a data subcarrier included in the frame, identifies a pilot sequence corresponding to the position of the pilot subcarrier, detects a seed value from the pilot sequence, and detects information related to an Orthogonal Frequency Division Multiplexing (OFDM) symbol index, using the position of the pilot subcarrier and the seed value,
wherein the pilot sequences are inserted into a determined subcarrier position of the frame according to a pilot pattern, and
wherein the pilot sequence is generated by applying a Zadoff-Chu sequence to each of a plurality of seed values including the seed value.

17. The apparatus of claim 16, wherein the seed value is determined according to an OFDM symbol interval.

18. The apparatus of claim 17, wherein the seed value is defined as
$${u}_{l} = ⌊ \frac{l}{{D}_{y}} ⌋ ,$$
where D_{y} denotes the OFDM symbol interval and l denotes a position of an OFDM symbol.

19. The apparatus of claim 18, wherein the pilot sequence is defined as
$${x}_{l} ( n ) = {e}^{- j \frac{π {u}_{l} n ( n - 1 )}{{N}_{p}}} , \\ 0 \leq n \leq {N}_{p} - 1$$
where xₗ(n) denotes a pilot sequence of a first OFDM symbol, and Nₚ denotes a length of the pilot sequence of the first OFDM symbol.

20. The apparatus of claim 19, wherein the information related to the OFDM symbol index is defined as Dₓuₗ+l mod D_{y},
where l mod D_{y} denotes a position value of the pilot subcarrier, uₗ denotes the seed value, and Dₓ denotes an interval at which the pilot sequence is shifted.
